(19) United States
(12) Patent Application Publication
(10) Pub. No.: US 2010/0110920 A1
(43) Pub. Date: May 6, 2010

(54) METHOD USED FOR RADIO MEASUREMENT AND A COMMUNICATION NODE IN A COMMUNICATION NETWORK

(75) Inventors: Yongqiang LIU, Beijing (CN); Yong Xia, Beijing (CN); Quan Huang, Beijing (CN); Gang Wang, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China) Co., Ltd., Beijing (CN)

(21) Appl. No.: 12/569,261

(22) Filed: Sep. 29, 2009

(30) Foreign Application Priority Data
Oct. 31, 2008 (CN) 200810175952.1

(51) Int. Cl. H04L 12/26

(52) U.S. Cl. 370/252; 370/338; 370/400

(57) ABSTRACT

A method used for radio measurement in a communication network is provided. The communication network comprises multiple basic service sets controlled by a core network controller. The method comprises the steps of: the core network controller issuing a measurement request to a communication node working on a service channel; the communication node switching to a non-service channel based on the measurement request; the communication node broadcasting a measurement beacon in the non-service channel and returning to the service channel immediately after the broadcasting; a node in the non-service channel receiving the measurement beacon; and based on the measurement beacon, calculating the received signal strength indicator (RSSI) from the communication node to the node in the non-service channel.

### FIELD OF THE INVENTION

The present invention relates generally to a communication network, and more particularly, relates to a method used for radio measurement and a communication node in a communication network.

### BACKGROUND OF THE INVENTION

Currently, as communication requirements increasingly grow, the Wireless Local Area Networks (WLANs) have been put into broad use. Generally, a WLAN architecture is based on an IEEE 802.11 infrastructure network. FIG. 1 illustrates a conventional IEEE 802.11 WLAN system architecture.

As shown in FIG. 1, a WLAN 100 comprises multiple basic service sets (BSSs), wherein each BSS is composed of an access point (AP) and one or more wireless terminal devices associated with the access point. The wireless terminal devices may be mobile communication devices, personal computers, personal digital assistants (PDAs), and so on. Each BSS (comprising the AP and the wireless terminal devices associated with it) operates on a signal channel entirely. For example, BSS1 operates on channel 1, BSS2 operates on channel 6, and the like. Neighboring BSSs operate on different and distinct channels. The whole WLAN 100 is controlled by a core network controller (CNC).

In the WLAN, there is a demand for radio strength measurement. Radio strength measurement means a node in a BSS (it may be an AP, or a wireless terminal device) is required to measure the strength of the radio wave from a node in another BSS (also, it may be an AP, or a wireless terminal device) to itself. Radio strength measurement is very useful to optimization of WLANs, such as channel assignment, load balancing and mobility management. The demand for radio strength measurement may be triggered by a periodic instruction from the core network controller, or may be instructed by the core network controller if it is necessary to reconfigure the network, conduct handover due to movement of the node, for example.

As described above, neighboring BSSs work in different channels. Thus, to enable a node (referred to as “measuring node” hereinafter) to measure the strength of the radio wave from one or more other nodes (referred to as “measured nodes” hereinafter) in a neighboring channel, the following operations are required. First, it is necessary for the measuring node to leave its serving channel, that is, the channel on which the measuring node is operating, and switch to the neighboring channel of the measured nodes (referred to as “non-serving channel” hereinafter). Obviously, during the switch over, the measuring node cannot operate on its own serving channel, and thus cannot exchange packets during the measurement period. For simplicity, this period is called “serving channel leaving time”.

Next, on the non-serving channel, the measuring node conducts a listen and waits for signals transmitted from the one or more other nodes in the non-serving channel. Once the signals are received, the measuring node may calculate the received signal strength indicator (RSSI) from these measured nodes to itself, and then return its own serving channel. At this time, the measure process by the measuring node on nodes in the non-serving channel is completed.

Moreover, if it is necessary for the measuring node to measure the strength of the radio wave from nodes in other neighboring channels (that is to say, the RSSI information from these nodes to the measuring node itself is required), the measuring node may switch itself to these non-serving channels one by one (this is because the measuring node may operate on only one channel at a time) and perform the same operations as described above.

Please note that in a BSS, only one frame is transmitted in one slot. For example, to avoid collision, IEEE 802.11 defines CSMA/CA (Carrier Sense Multiple Access/Collision Avoidance) mechanism to schedule the packet transmission in one BSS. Using CSMA/CA, only one frame can be transmitted one time slot in the channel of BSS. FIG. 2 illustrates a case in which there are M measuring nodes and N measured nodes from network view. For ease of explanation, assume that the N measured nodes exist in a same channel. As shown in FIG. 2, each of the M measuring nodes needs to leave its own serving channel, switch to the non-serving channel on which the N measured nodes operate, and conduct a listen. As stated above, since in one time slot in the channel only one frame is transmitted, if assume capturing one frame uses time t1 (here time t1 can be considered as equal to one slot), in an ideal case, the time cost for capturing N frames from the N measured nodes is N*t1. Please note that the term “ideal case” means there is no delay between the capturing of the N frames, therefore, in an actual case, the time cost required should be larger than N*t1.

That is to say, for a measuring node, it is necessary to spend total time of N*t1 to capture N frames from N measured nodes. Accordingly, the serving channel leaving time of the measuring node is N*t1. So, for M measuring nodes, the total time cost of the network required by the measure procedure is M*N*t1.

FIG. 3 illustrates the same case as FIG. 2, but from node view. As an example, a case in which one measuring node measures two measured nodes in a same channel is illustrated. Obviously, a case in which there are M measuring nodes and N measured nodes could easily conceived by those skilled in the art.

FIG. 4 illustrates a flow chart 400 of the above measurement procedure. For ease of explanation, FIG. 4 illustrates a working flow of only one measuring node. Needless to say, if there are multiple measuring nodes, repeating the flow in FIG. 4 is enough.

As shown in FIG. 4, in step 401, a measuring node receives a measurement request. As described above, the measurement request may be originated by a core network controller at a higher layer in response to a demand of network reconfiguration, or may be originated by the core network controller periodically. The receipt of the measurement request serves to make the measuring node switch from its normal communicating state (“serving state”) to a measuring state. In step 402, according to the measurement request, the measuring node switches to a non-serving channel in which measure process is required. That is, the measuring node switch its operating frequency from the frequency of its serving channel to the frequency of the non-serving channel, such as from 2.412 GHz to 2.462 GHz. In step 403, the measuring node receives a frame from a measured node in the non-serving channel. In step 404, the measuring node calculates the RSSI from the measured node to itself according to the received frame, wherein the RSSI can be used as an indicator of the strength of the radio wave from the measured node to the measuring node. In step 405, it is determined whether or not it is required to measure other nodes in the non-serving channel. That is, it is determined whether or not there are multiple measured nodes in the non-serving channel, as indicated by the measurement request received in step 401. If the result is positive (Yes), the measuring node returns to step 403 to continue the measure process, and if the result is negative (No), the measuring node switches back to its serving channel in step 406. The measure process of the radio strength is completed.

### SUMMARY OF THE INVENTION

As stated above, during the measure period, the measuring node leaves its own serving channel and cannot exchange packets (provide service) during this period just like in normal communication. Therefore, the longer the leaving time of the measuring node is, the more serious the degradation of the network performance is.

The performance degradation of the network during the non-serving channel measure process should be alleviated. In other words, the serving channel leaving time should be reduced.

According to one aspect of the invention, a method used for radio measurement in a communication network is provided. The communication network comprises multiple basic service sets controlled by a core network controller. The method comprises the steps of: the core network controller issuing a measurement request to a communication node working on a service channel; the communication node switching to a non-service channel based on the measurement request; the communication node broadcasting a measurement beacon in the non-service channel and returning to the service channel immediately after the broadcasting; a node in the non-service channel receiving the measurement beacon; and based on the measurement beacon, calculating the received signal strength indicator (RSSI) from the communication node to the node in the non-service channel.

According to another aspect of the invention, a communication node in a communication network is provided. The communication network comprises multiple basic service sets controlled by a core network controller. The communication node comprises a radio measurement module, the radio measurement module comprising: a measurement request receiving module, for receiving a measurement request from the core network controller; and a switching module, for switching to a non-service channel in response to the received measurement request, broadcasting a measurement beacon in the non-service channel, and causing the communication node to return to a service channel immediately after the broadcasting.

According to another aspect of the invention, a communication system comprising a measuring communication node and a measured communication node working on different channels and a core network controller controlling the measuring communication node and the measured communication node is provided, wherein the core network controller contains a measurement originating unit, for sending a measurement request to the measuring communication node. The measuring communication node contains: a measurement request accepting unit, for accepting the measurement request from the measurement originating unit; a channel switching and measurement beacon transmitting unit, for switching to a non-service channel based on the measurement request upon receipt of the measurement request, and broadcasting a measurement beacon in the non-service channel and returning to a service channel immediately after the broadcasting. The measured communication unit contains a measurement unit, for calculating the received signal strength indicator (RSSI) from the measuring communication node to the measured communication node upon receipt of the measurement beacon.

According to another aspect of the invention, a channel assignment controlling apparatus is provided, comprising: a measurement originating unit, for sending a measurement request to a measuring communication node; a measurement result receiving unit, for receiving a measurement result sent from a measured communication node as response to the measurement request; and a channel assigning unit, for assigning channels according to the measurement result.

### BRIEF DESCRIPTION OF THE DRAWINGS

FIG. 1 illustrates a conventional WLAN 100;

FIG. 2 illustrates, from network view, a case there are M measuring nodes and N measured nodes;

FIG. 3 illustrates, from node view, a case there are one measuring node and two measured nodes;

FIG. 4 illustrates a flow chart of a conventional non-serving channel radio measurement;

FIG. 5A illustrates a flow chart of radio measurement used in a communication network according to the invention;

FIG. 5B illustrates the content of the exemplary measurement beacon used in the radio measurement according to the invention;

FIG. 6 illustrates a flow chart of a non-serving channel radio measurement method according to a first embodiment of the invention;

FIG. 7 illustrates, from node view, a case in which there are two measuring nodes and two measured nodes according to the first embodiment;

FIG. 8 illustrates, from network view, a case in which there are two measuring nodes and two measured nodes according to the first embodiment;

FIG. 9 illustrates a flow chart of a non-serving channel radio measurement method according to a second embodiment of the invention;

FIG. 10 illustrates, from node view, a case in which there are two measuring nodes and two measured nodes according to the second embodiment;

FIG. 11 illustrates, from network view, a case in which there are two measuring nodes and two measured nodes according to the second embodiment;

FIG. 12 illustrates a radio measurement module according to the invention;

FIG. 13 illustrates a schematic view of the structure of a whole communication system according to the invention; and

FIG. 14 illustrates a case in which the core network controller is implemented as a channel assignment controlling apparatus for use in channel assignment.

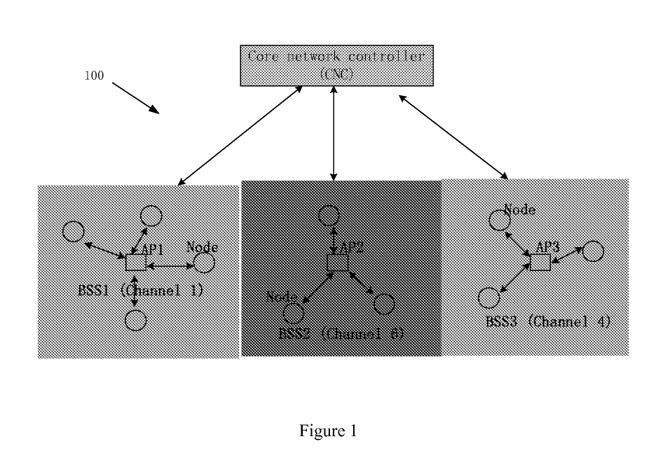

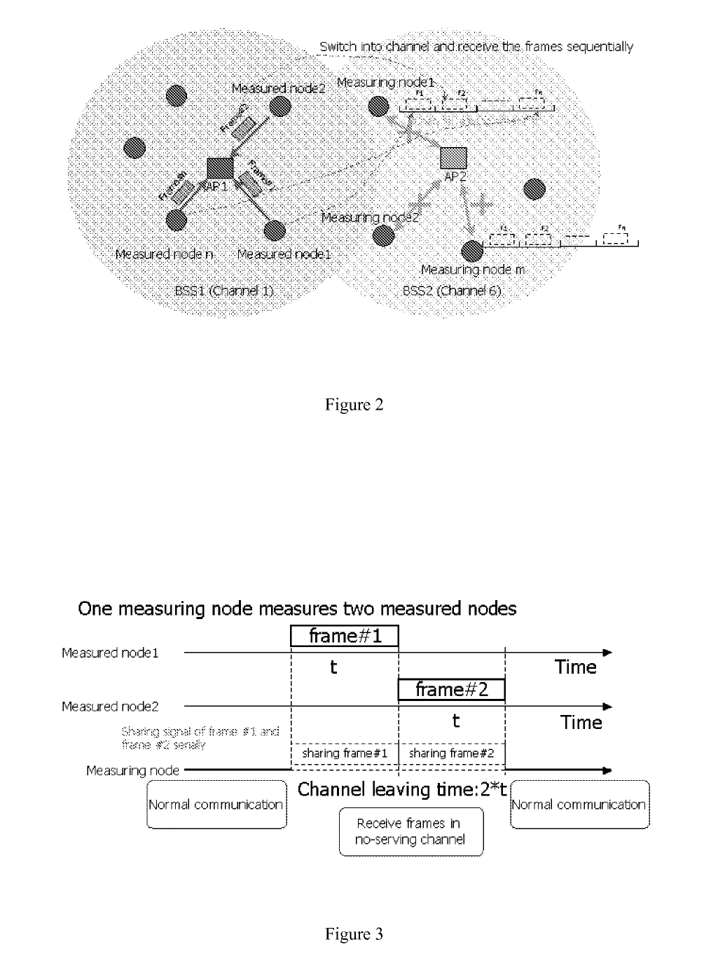

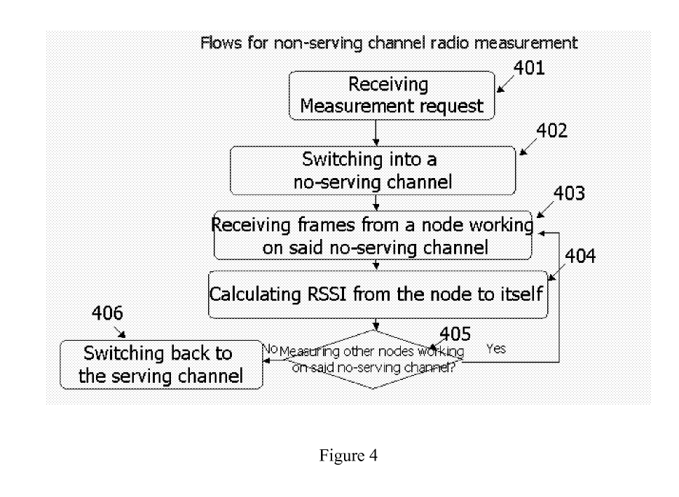

### DETAILED DESCRIPTION

Various embodiments of the present invention will now be described in detail with reference to the accompanying drawings.

As stated above, in the conventional technique, in case that there are M measuring nodes and N measured nodes, the total time cost is M*N*t1, because each measuring node's leaving time is N*t1, that is to say, one measuring node must stay in the non-serving channel for total time of N*t1 to receive N frames transmitted from the N measured nodes, since in one slot only one frame is transmitted, as described above.

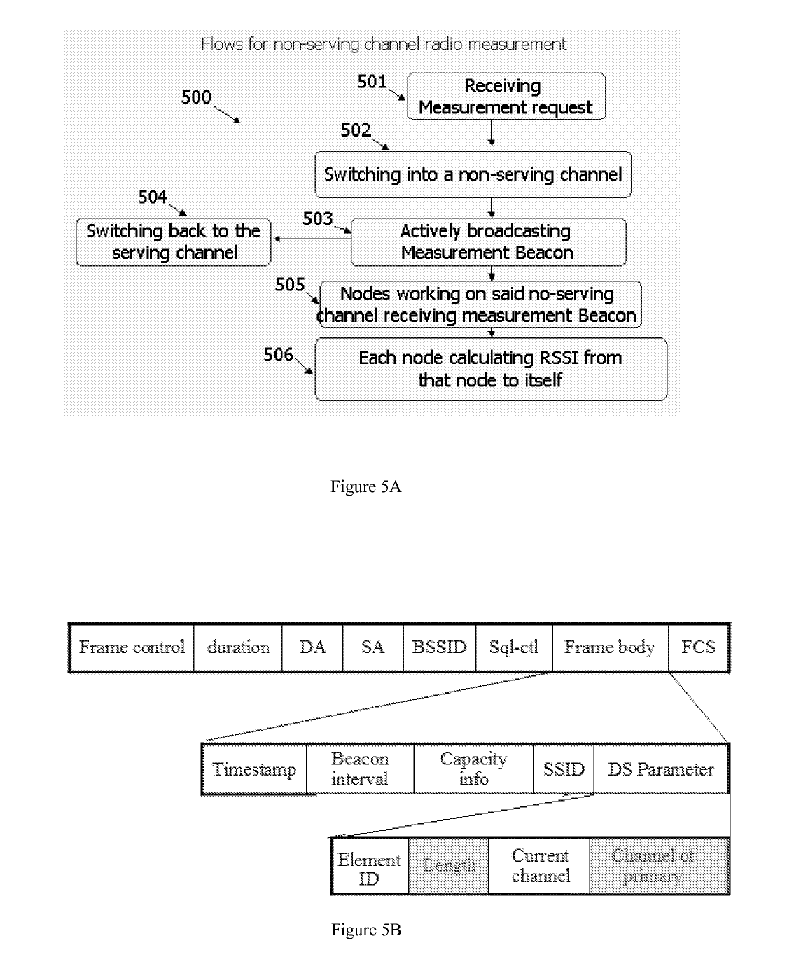

FIG. 5A illustrates a flow chart 500 of the radio measurement in a communication network according to the present invention. The flow in FIG. 5A can be implemented in a measuring node, and can also be implemented in a measured node. As shown in FIG. 5A, in step 501, (the measuring node or the measured node) receives a measurement request. In step 502, (the measuring node or the measured node) switches to a non-serving channel. In step 503, (the measuring node or the measured node) broadcasts a measurement beacon in the non-serving channel, and returns to the serving channel immediately. In step 505, the nodes in the non-serving channel receive the measurement beacon. In step 506, each node receiving the measurement beacon calculates the RSSI from the transmitting node (i.e., the measuring node) to itself according to the received measurement beacon.

FIG. 5B illustrates the content of the exemplary measurement beacon used in the radio measurement according to the present invention of FIG. 5A. The destination MAC address of the beacon is set as FF:FF:FF:FF:FF:FF such that all of the nodes in the non-serving channel can receive the measurement beacon. In the beacon content illustrated in FIG. 5B, the grey fields are the new or modified fields. In the measurement beacon, a new field “Channel of primary” is appended, indicating the node's working channel (i.e., the serving channel). Accordingly, the length value in the DS parameter field is changed from 1 to 2.

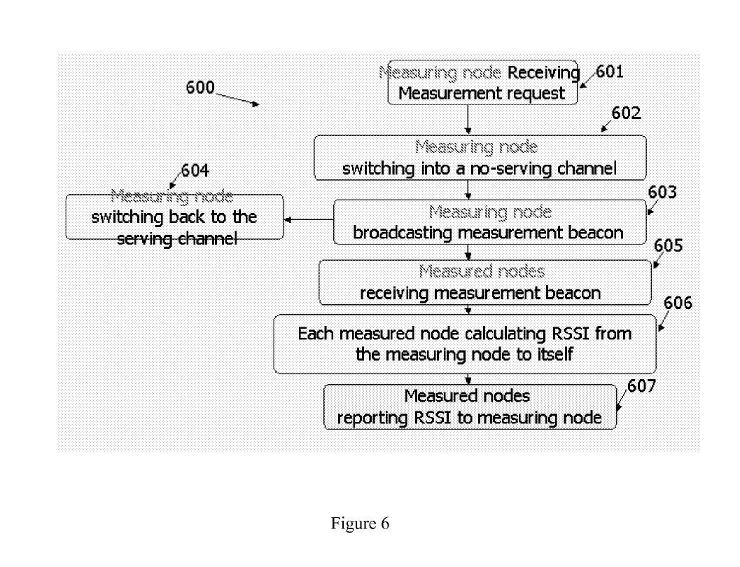

The flow of FIG. 5A can be implemented in a measuring node or a measured node. Below the two cases will be described respectively. FIG. 6 illustrates a flow chart 600 of a non-serving channel radio measurement method according to a first embodiment of the invention, which is implemented in a measuring node.

As shown in FIG. 6, in step 601, the measuring node receives a measurement request, the measurement request being indication for measurement from the core network controller. In step 602, according to the measurement request, the measuring node switches to a non-serving channel in which measurement is required. That is, the measuring node switches its operating frequency from the frequency of the serving channel to that of the non-serving channel, such as from 2.412 GHz to 2.462 GHz. In step 603, the measuring node actively broadcasts a measurement beacon in the non-serving channel, and switches back to its serving channel immediately in step 604. In step 605, all of the nodes operating on the non-serving channel receive the measurement beacon almost simultaneously (Please note that since the distances from the respective nodes to the measuring node are distinct, the receipt time of the respective nodes would have a slight difference, but this slight difference may be omitted in the discussion in the present invention). If a node receiving the measurement beacon is not the measured node designated in the measurement request, the node does not take any action on the received measurement beacon, but drops it directly. On the other hand, if the node is the measured node to be measured, the node receiving the measurement beacon calculates the RSSI from the measuring node to itself according to the received measurement beacon in step 606, and approximately uses this RSSI value as the RSSI from itself to the measuring node. In step 607, the measured node reports this RSSI value to the measuring node having returned to its serving channel (Needless to say, the reporting step is necessary in this case, because at this time only the measured node acquires the RSSI from the measuring node to itself, however, the measuring node itself, which have originated the measuring action according to the measurement request, does not know this information yet). Then, the measuring node may report the acquired RSSI to the higher-layer core network controller (This step is not illustrated in FIG. 6). And the core network controller may schedule the subsequent measurement procedure (or the measurement procedure for other nodes) according to the reported information.

Please note that the measurement beacon is transmitted from the measuring node to the respective measured nodes. Therefore, the RSSI calculated from this measurement beacon is the RSSI from the measuring node to the respective measured node. However, because this RSSI is approximately equal to the RSSI in the reverse direction, i.e., from the measured node to the measuring node, which is actually desired, the calculated RSSI can be used as the RSSI from the respective measured node to the measuring node.

As can be seen from FIG. 6, in the embodiment of the invention, the serving channel leaving time of the measuring node is only the time required for the measuring node to switch to the neighboring non-serving channel and broadcast the measurement beacon in the non-serving channel. The switching time may be omitted (actually in the conventional technique the switching time is not considered either). Assume that the time required to broadcast the measurement beacon is t2, for a measuring node, the serving channel leaving time is always t2 regardless of the number of the measured nodes in the non-serving channel. Obviously, this time t2 is independent of the number of the measured nodes. Assume that in an ideal case t2=t1 (in fact t2 may be less than t1 slightly). That is to say, in an ideal case the time required to broadcast a measurement beacon is also a time slot. In the following description, assume that t2=t1=t for ease of description.

As can be seen, the method according to the invention may significantly reduce the serving channel leaving time of the measuring node, for example from N*t to t. Regardless of the number of the measured nodes, the measuring node will return to its serving channel immediately after the transmission of the measurement beacon. Therefore, the serving channel leaving time may be significantly reduced.

The measurement beacon described in FIG. 6 is a frame having a destination MAC address of FF:FF:FF:FF:FF:FF such that all of the nodes in the non-serving channel can receive the beacon. Moreover, the measurement beacon further comprises the MAC address and serving channel of the source node (i.e., the measuring node) and a flag bit for indicating that the measurement beacon is used for radio measurement (to distinguish from a normal beacon). The MAC address and serving channel is employed to report the calculated RSSI value to the measuring node by the measured node. Reporting of the RSSI can be classified into the following four cases: 1) in case that the measuring node is an AP and the measured node is also an AP, the reporting path of the RSSI is from the measured node to the measuring node; 2) in case that the measuring node is an AP and the measured node is a wireless terminal device, the reporting path of the RSSI is from the measured node to the AP of the measured node, and then to the measuring node; 3) in case that the measuring node is a wireless terminal device and the measured node is an AP, the reporting path of the RSSI is from the measured node to the AP of the measuring node, and then to the measuring node; 4) in case that the measuring node is a wireless terminal device and the measured node is also a wireless terminal device, the reporting path of the RSSI is from the measured node to the AP of the measured node, then to the AP of the measuring node, and then to the measuring node. Please note that in the above cases, the communication between APs is a wired communication. And in any of the above cases, whether the measuring node or the measured node does not need to leave its serving channel.

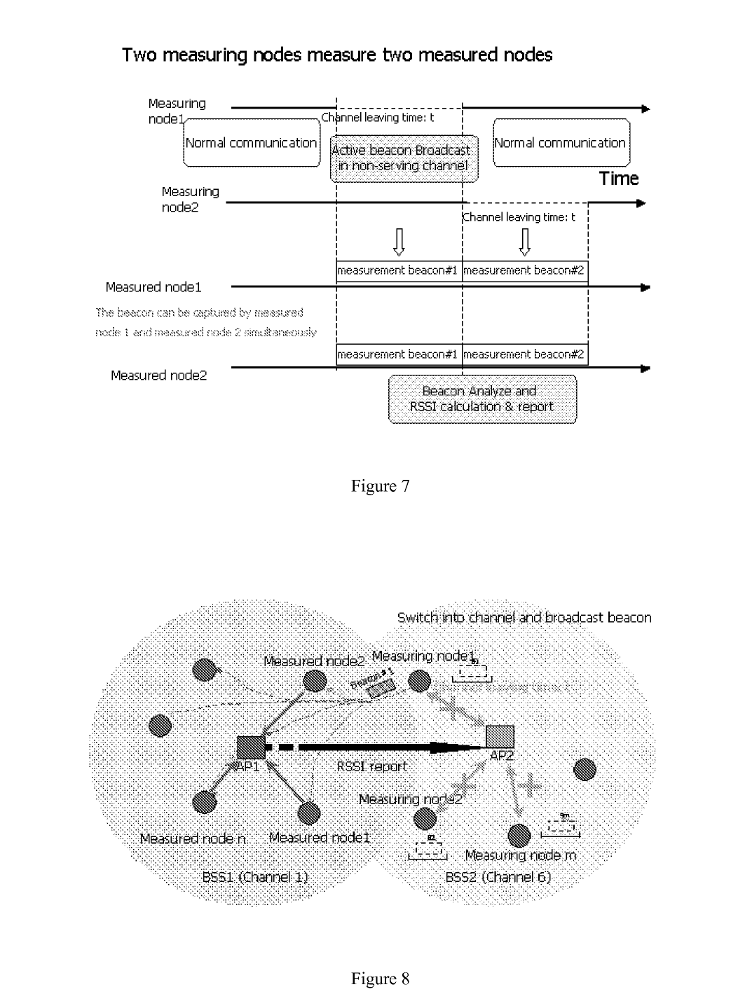

FIG. 7 illustrates, from node view, a case in which there are two measuring nodes and two measured nodes according to the first embodiment. FIG. 8 illustrates the same case as FIG. 7, but from network view. Based on the flow chart in FIG. 6, in FIGS. 7 and 8, upon receipt of the measurement request, the measuring node switches to the channel of the measured node and actively broadcasts the measurement beacon.

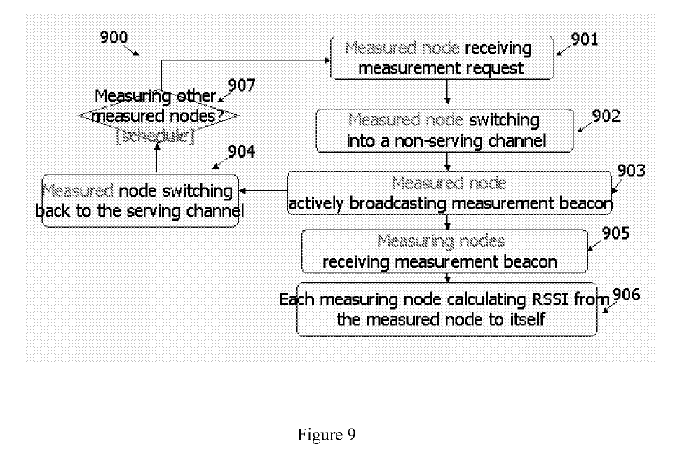

The flow in FIG. 6 can be applied to a case in which the number of the measuring nodes M is equal to or less than the number of the measured nodes N. However, the situation may be varied. In case that the number of the measuring nodes M is larger than the number of the measured nodes N, the serving channel leaving time of the measured nodes may be reduced by implementing the inventive concept of the invention in the measured nodes. FIG. 9 illustrates a flow chart 900 of a non-serving channel radio measurement method according to a second embodiment of the invention, which is implemented in a measured node.

As shown in FIG. 9, in this case, in step 901 a measured node receives a measurement request from the core network controller at a higher layer. In step 902 the measured node switches to a neighboring channel on which the M measuring nodes operate (Likewise, for ease of explanation, assume that the M measuring nodes operate on a same channel). In step 903, the measured node actively broadcasts a measurement beacon, and immediately switches back to its serving channel in step 904. In step 905, all of the measuring nodes in the channel receives the measurement beacon, and calculates the RSSI according to the measurement beacon, wherein the RSSI calculated represents the RSSI from the measured node originating the measurement beacon to the measuring node receiving the beacon. That is to say, in step 906 the RSSI from the measured node to the respective measuring node may be acquired by each of the measuring nodes. Therefore, a step of reporting the RSSI to the measured node is not necessary in this case. Also, the measuring node will report the calculated RSSI to the higher-layer CNC subsequently to enable the CNC schedule the subsequent measurement and the measurement of other nodes (as in FIG. 6 above, this step is not shown).

If there are multiple measured nodes to be measured, the next measured node will switch to the channel of the M measuring nodes and begin the flow illustrated in FIG. 9. Obviously, in this case, the total time cost of the N measured nodes is N*t.

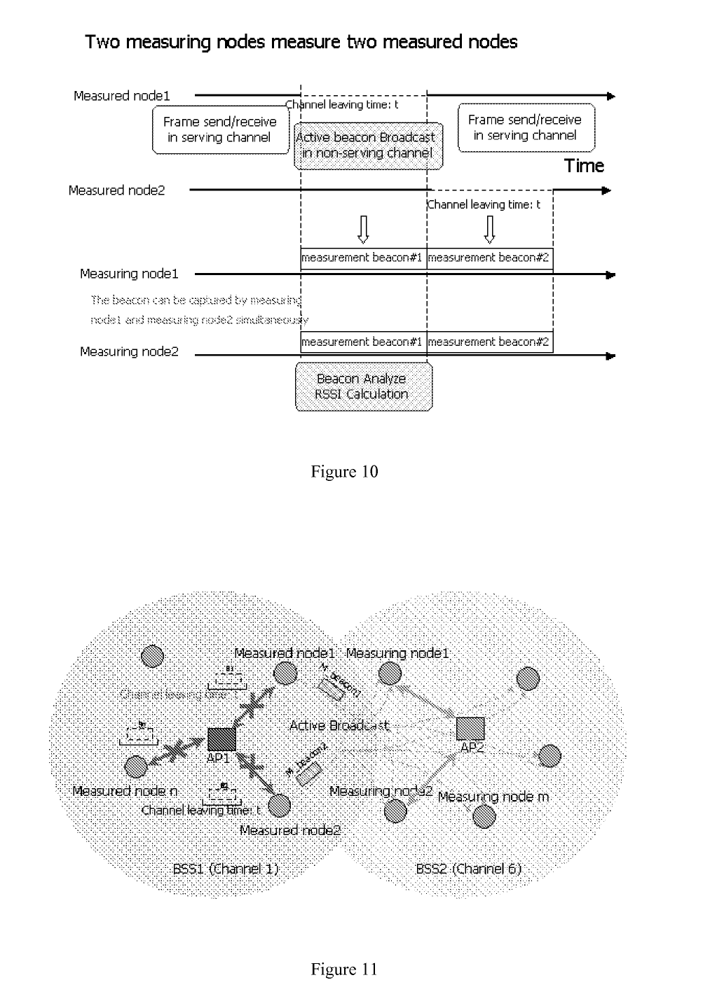

FIG. 10 illustrates, from node view, a case in which there are two measuring nodes and two measured nodes according to the second embodiment. FIG. 11 illustrates the same case as FIG. 10, but from network view. As can be seen from the flow in FIG. 9, in FIGS. 10 and 11, upon receipt of the measurement request, the measured node may switch to the channel of the measuring node and actively broadcast the measurement beacon.

Please note that in case that the measured node switches to the channel of the measuring node and actively broadcasts the measurement beacon, in order to manage and schedule the switch over of multiple measured nodes, a “schedule” step 907 is added into the flow chart of FIG. 9, in which it is determined whether there are still other measured nodes to be measured. If the result is “Yes”, the flow returns to step 901 and the next measured node begins the flow in FIG. 9. However, this “schedule” step in not necessary in the flow chart of FIG. 6, because in the measurement request received by the measuring node, there is information about which measured nodes will be measured by this measuring node. On the contrary, in the measurement request received by the measured node, only information about the channel the measuring node is operating on is contained, but information on which measured nodes need to be measured by this measuring node is not available. Therefore, this “schedule” step is necessary in the flow of FIG. 9. Furthermore, the “schedule” step is implemented in the core network controller.

As stated above, in the first and second embodiment, the measurement request is originated from the core network controller at a higher layer. In this case, the core network controller will have a function of determining whether to employ the method of the first embodiment or to employ the method of the second embodiment according to the comparison between the number of the measuring nodes and that of the measured nodes.

Please note that the method of the invention may be embodied in software, hardware and/or firmware or the combination thereof. Moreover, the method of the invention may be embodied in an AP and/or a wireless terminal device.

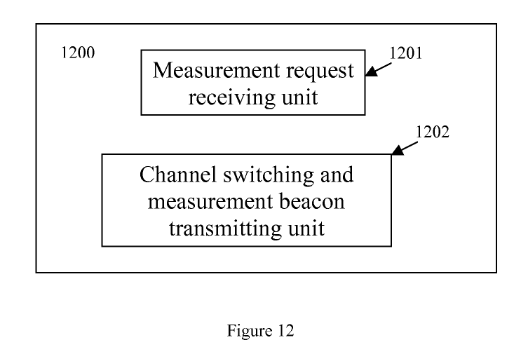

FIG. 12 illustrates a radio measurement module 1200 used in a communication node (a measuring node or a measured node) according to the invention. The module 1200 may be embodied in an AP and/or a wireless terminal device as a communication node in a communication network. The module 1200 comprises a measurement request receiving unit 1201 and a channel switching and measurement beacon transmitting unit 1202. The measurement request receiving unit 1201 is configured to receive the measurement request from the core network controller. The channel switching and measurement beacon transmitting unit 1202 is configured to, in response to the received measurement request by the measurement request receiving unit 1201, switch to a neighboring channel (i.e., the non-serving channel) and broadcast a measurement beacon in the channel, and return to its operating channel (i.e., serving channel) immediately after broadcasting of the measurement beacon. Other constituent parts of the AP and/or wireless terminal device are well-known to those skilled in the art, such as a communication unit, a data processing unit and/or a control unit. Therefore, these constituent parts are not described detailedly in the specification. Also, as stated above, the communication node above may be implemented in a communication network such as 802.11 WLAN.

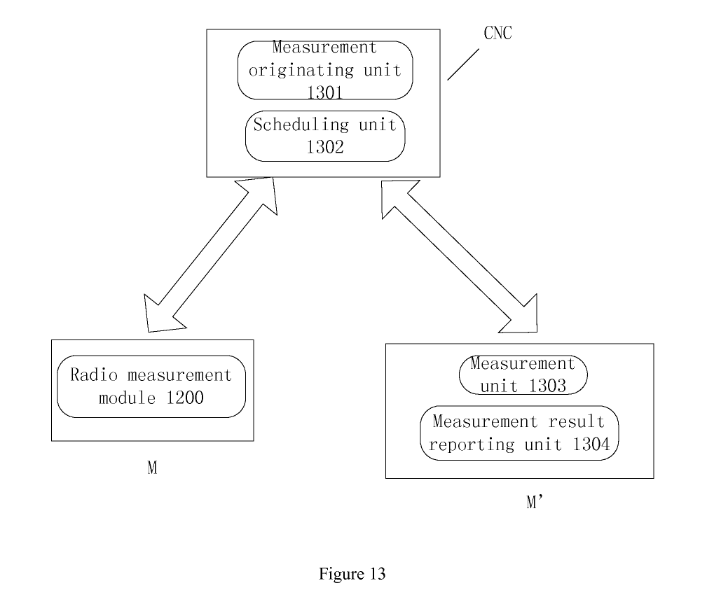

FIG. 13 illustrates a schematic view of the structure of a whole communication system according to the invention. The communication system is composed of three parts: a core network controller, one or more measuring nodes and one or more measured nodes. For simplicity, only one measuring node M and one measured node M′ are illustrated in FIG. 13. Obviously, the number of the measuring nodes may be arbitrary, and the number of the measured nodes may be arbitrary also.

In FIG. 13, the core network controller comprises a measurement originating unit 1301 configured to originate a measurement request to one or more communication nodes in the network according to an instruction from a central controlling part such as CPU and so on (not shown) in the core network controller. At this time, it has been determined by the core network controller which nodes are measuring nodes and which nodes are measured nodes. Such determination is not relevant to the invention, and thus is omitted in the specification.

Assume that the measurement request is transmitted to the measuring node, thereby making the measuring node switch to the channel of the measured node.

In this case, the measuring node in FIG. 13 comprises the radio measurement module 1200 illustrated in FIG. 12 whose components and functions have has been described above. In FIG. 13, the measured node comprises a measurement unit 1303 configured to calculate the RSSI value from the measuring node M to the measured node M′ according to the received measurement beacon upon receipt of the measurement beacon. Furthermore, if desired, the measured node may further comprise a measurement result reporting unit 1304 configured to report the calculated RSSI to the measuring node and to the core network controller. As stated above, the measurement result reporting unit 1304 is not necessary.

If necessary, the core network controller illustrated in FIG. 13 may further comprise a scheduling unit 1302 for performing scheduling to determine whether there are still other measured nodes to be measured. By the way, the scheduling unit 1302 may be omitted in the core network controller. For example, if it has been determined by the core network controller that the number of the measuring nodes is greatly less than that of the measured nodes, this unit 1302 may not be included.

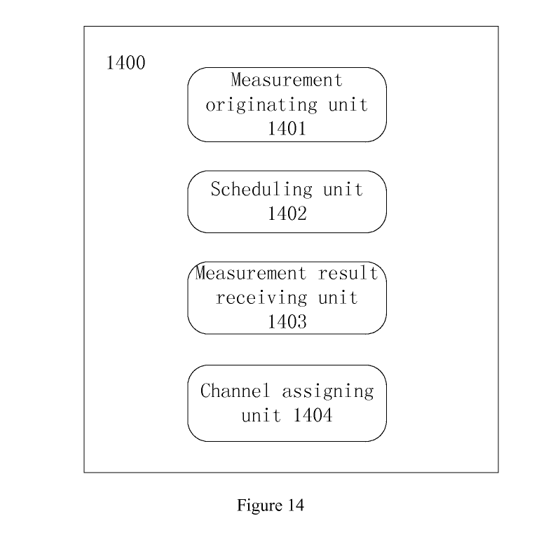

As described above, radio strength measurement is very useful to optimization of WLANs, such as channel assignment, load balancing and mobility management. FIG. 14 illustrates a case in which the core network controller is implemented as a channel assignment controlling apparatus for use in channel assignment. As shown, the apparatus 1400 comprises a measurement originating unit 1401 and a scheduling unit 1402. The measurement originating unit 1401 is substantially equivalent to the unit 1301, however the scheduling unit 1402 is slightly different from 1302. In such case the scheduling unit 1402 is further configured to schedule the transmission of the measurement requests to a plurality of measuring nodes. Furthermore, this apparatus further comprises a measurement result receiving unit 1403 for receiving the measurement result (i.e., the RSSI value) reported (transmitted) from the measured node and a channel assigning unit 1404 for assigning channels according to the measurement result, wherein the measurement result is the response to the measurement request transmitted by the measurement originating unit 1401.

Obviously, the above modules and units may be embodied in the form of software, hardware and/or firmware or the combination thereof. In addition, the communication node in the present invention is not limited to the AP and the wireless terminal device. It may be an arbitrary communication node capable of communicating in the communication network of the invention. Furthermore, the communication network of the invention is not limited to 802.11 WLAN as stated above, and may be applied to any wired or wireless communication network, including a communication network compliance with IEEE standard.

It should be understood by those skilled in the art that the present invention is not limited to the above embodiments. The protection scope of the invention should be defined only by the following claims.

What is claimed is:

1. A method used for radio measurement in a communication network, said communication network comprising multiple basic service sets controlled by a core network controller, the method comprising:
said core network controller issuing a measurement request to a communication node working on a service channel;
said communication node switching to a non-service channel based on said measurement request;
said communication node broadcasting a measurement beacon in said non-service channel and returning to said service channel immediately after said broadcasting;
a node in said non-service channel receiving said measurement beacon; and
based on said measurement beacon, calculating the received signal strength indicator (RSSI) from said communication node to said node in said non-service channel.

2. The method according to claim 1, wherein said communication network is a 802.11 wireless local area network.

3. The method according to claim 1, wherein said communication node is a wireless terminal device.

4. The method according to claim 1, wherein said communication node is an access point.

5. The method according to claim 1, further comprising:
after receiving said measurement beacon, said node in said non-service channel measuring the content of said beacon.

6. The method according to claim 5, wherein said node in said non-service channel identifies the address of said communication node according to the measured content of said beacon.

7. The method according to claim 6, wherein said node in said non-service channel reports the calculated RSSI to said communication node in said service channel based on the identified address.

8. The method according to claim 1, further comprising:
if said communication node is a communication node to be measured, said core network controller performing scheduling to judge whether or not there are still other communication nodes to be measured.

9. A communication node in a communication network, said communication network comprising multiple basic service sets controlled by a core network controller, said communication node comprising a radio measurement module, said radio measurement module comprising:
a measurement request receiving module, for receiving a measurement request from said core network controller; and
a switching module, for switching to a non-service channel in response to the received measurement request, broadcasting a measurement beacon in said non-service channel, and causing said communication node to return to a service channel immediately after said broadcasting.

10. The communication node according to claim 9, wherein said communication network is a 802.11 wireless local area network.

11. The communication node according to claim 9, wherein said communication node is a wireless terminal device.

12. The communication node according to claim 9, wherein said communication node is an access point.

13. A communication system, comprising a measuring communication node and a measured communication node working on different channels and a core network controller controlling said measuring communication node and said measured communication node, wherein
said core network controller contains a measurement originating unit, for sending a measurement request to said measuring communication node;
said measuring communication node contains:
a measurement request accepting unit, for accepting said measurement request from said measurement originating unit;
a channel switching and measurement beacon transmitting unit, for switching to a non-service channel based on said measurement request upon receipt of said measurement request, and broadcasting a measurement beacon in said non-service channel and returning to a service channel immediately after said broadcasting;
said measured communication unit contains:
a measurement unit, for calculating the received signal strength indicator (RSSI) from said measuring communication node to said measured communication node upon receipt of said measurement beacon.

14. The communication system according to claim 13, wherein said measured communication node further comprising a measurement result reporting unit, for reporting the calculated RSSI to said measuring communication node.

15. The communication system according to claim 13, wherein said core network controller further comprising a scheduling unit, for performing scheduling to judge whether or not there are still other measured communication nodes to be measured.

16. The communication system according to claim 13, wherein said communication system works in a 802.11 wireless local area network.

17. The communication system according to claim 13, wherein said measuring communication node is an access point, while said measured communication node is a wireless terminal device.

18. The communication system according to claim 13, wherein said measured communication node is an access point, while said measuring communication node is a wireless terminal device.

19. A channel assignment controlling apparatus, comprising:
a measurement originating unit, for sending a measurement request to a measuring communication node;
a measurement result receiving unit, for receiving a measurement result sent from a measured communication node as response to said measurement request; and
a channel assigning unit, for assigning channels according to said measurement result.

20. The channel assignment controlling apparatus according to claim 19, further comprising a scheduler, for scheduling transmission of said measurement request to multiple measuring communication nodes.
